(19) United States
(12) Patent Application Publication
(10) Pub. No.: US 2007/0095488 A1
(43) Pub. Date: May 3, 2007

(54) Safety device of two-way braking for a retractable door leaf

(75) Inventor: Hai-Sheng Huang, Lung Tan Hsian (TW)

Correspondence Address: TROXELL LAW OFFICE PLLC, SUITE 1404, 5205 LEESBURG PIKE, FALLS CHURCH, VA, 22041, US

(73) Assignee: Chun-Hsing Lin

(21) Appl. No.: 11/263,924

(22) Filed: Nov. 2, 2005

(51) Int. Cl. E06B 9/56

(52) U.S. Cl. 160/310

(57) ABSTRACT

A safety device of two-way braking for a retractable door leaf is especially applied to a retractable door which can be retracted and released vertically or horizontally. By using a triggering device installed, a signal can be transmitted to a host of the door to cope with an external condition, and in turn to command a working status of a motor, during a process of closing or opening the door. The invention is primarily composed of a door, and at least two two-way triggering devices located at a closing side of the door leaf. The triggering devices are acted by a guarding plate located at the closing side, and are subjected to a touch piece located at the door in the other way. A command can be generated for providing to a host by the aforementioned two-way activation, thereby controlling a working status of a motor.

### BACKGROUND OF THE INVENTION

(a) Field of the Invention

The present invention relates to a safety device of two-way braking for a retractable door leaf, and more particularly to a safety device that can provide a safety protection to a retractable door, which is collapsible, during a process of opening and closing the door, and a two-way dead point position for opening and closing the door so as to acquire a command of operation to a motor by a two-way triggering device.

(b) Description of the Prior Art

Of an ordinary retractable door such as an iron rolling door, a scissor-type retractable door, or a single sheet horizontal or vertical movement door, the door which is operated electrically is provided with a limiter 6 at a closing side 110 of a rolling door leaf 1 as shown in FIG. 1 for a safety protection, in addition to conventionally using a control button for manually operation. The limiter 6 is provided with a pressure switch 61 which faces a guarding plate 2 located at a lowest edge of the closing side 110. The guarding plate 2 is connected to a bottom edge of the closing side 110 with an elastic member 21, and a hoof 12 is formed at a bottom of the closing side 110.

After being acted on by the guarding plate 2, the pressure switch 61 will cut off a power to a motor, with a cut-off circuit being transmitted by a control wire 62. The limiter 6 is a switch, and hence the control wire 62 must be connected between the motor and the limiter 6. In addition, the control wire 62 must be attached to a surface of the door leaf. Accordingly, a cladding of the control wire 62 can be cracked or even the whole wire can be rolled over and cut into a half to cause a short circuit, due to a pressing and cutting force upon rolling the door leaf 1.

Referring to FIG. 2, other than the aforementioned stopping method, the hoof 12 located at a bottom of the door leaf 1 is connected with a flexible tube 91 via another method. The flexible tube 91 which is made by a material having an elastically restoring action forms deformation sides 911, 912 at two sides and its bottom surface 92 is in an arch shape in suspension due to a restoring effect of the deformation sides 911, 912. The flexible tube 91 contains a limiting switch 9 below which installed a touch button 90, which is electronically conducted by a control power 62. If the closing side 110 of the door leaf 1 touches a ground upon closing down the door, the bottom surface 92 of the flexible tube 91 will touch the tube 91 will touch the ground (or any barrier) first, which will indirectly activate the touch button 90 by which to have the limiting switch to generate a signal to create a command of operation to the motor via the control power 62. However, by using the aforementioned method, an elastic fatigue or even a rupture will occur to the flexible tube 91 by a long time of usage, thereby creating no action or allowing moisture to enter such that the limiting switch 9 is easy to be malfunctioning due to the rupture.

Referring to FIG. 2, to maintain comprehensively such that the door leaf 1 can have a safety protection during a process of rolling, a laser side 71 and a photo-induction side 72 are separately installed using a photoelectric host 7. A light beam 70 emitted from the laser side 71, which is connected to the photoelectric host 7 via a power wire 73, is received by the induction side 72. If the photo-induction side 72 loses a photo-induction signal, the photoelectric host 7 will determine that an alien object is entering the closing side 110, thereby providing a command of shutdown operation to a motor controller.

The laser side 71 and the photo-induction side 72 can be directly installed at a bottom position of the hoof 12 located at a lowest curtain 11, whereas it requires other control elements to control a rolling of an upper develop a unidirectional safety protection, and cannot achieve a dual purpose of overall stopping and safety.

### SUMMARY OF THE INVENTION

Accordingly, the primary object of the present invention is to provide a stopping control of rolling upper and lower dead points and to provide an overall safety protection during the rolling process, by using a two-way action with a plurality of two-way triggering devices located at a closing side of a door leaf.

Another object of the present invention is to prevent the triggering devices from being damaged by an elastic buffering of a touch piece; as to cope with a condition of a sudden stop caused by receiving a stop command during a process of moving up and down the door, the door will continually move up or down by a distance of about 10-15 mm due to the law of inertial of motion.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of an installation position of a conventional rolling door leaf provided with a limiter.

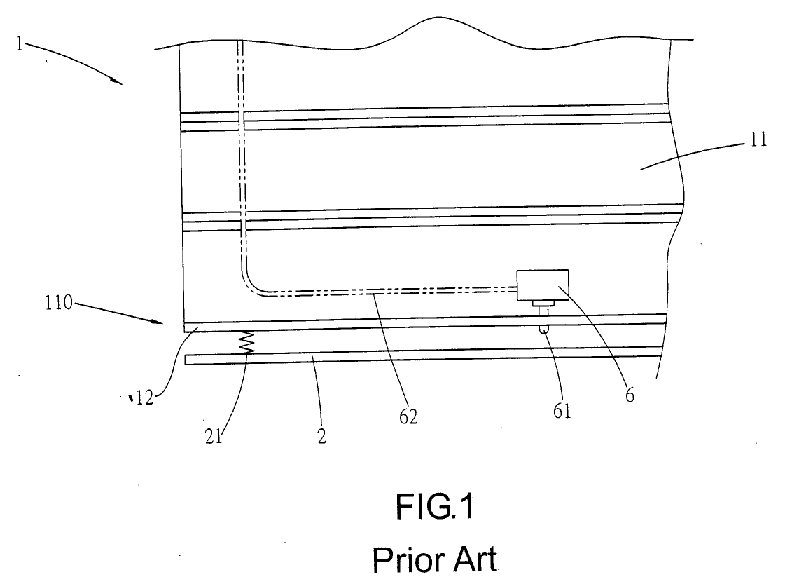

FIG. 2 shows another schematic view of an installation position of a limiter of a conventional rolling door leaf provided with a limiter.

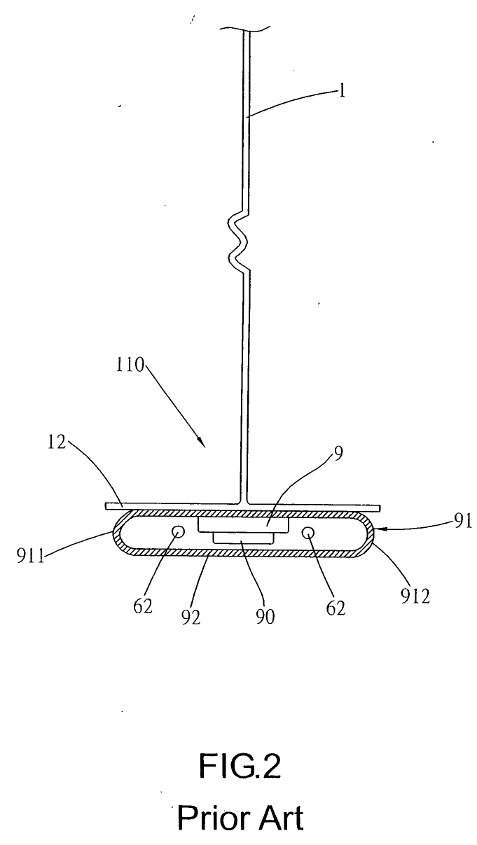

FIG. 3 shows a schematic view of a conventional door leaf provided with a photoelectric host at a closing side.

FIG. 4 shows a schematic view of a triggering device located at a closing side of a door leaf of the present invention.

FIG. 5 shows a schematic view of a relationship between a triggering device and a door structure of the present invention.

FIG. 6 shows a system diagram of electrical working of a triggering device of the present invention.

FIG. 7 shows a schematic view of a location of a triggering device relative to a door of the present invention.

FIG. 8 shows a schematic view of an operation of safety protection of a triggering device of the present invention.

FIG. 9 shows a perspective view of another implementation of a probing rod structure of the present invention.

FIG. 10 shows a working diagram of a second tact key of the present invention.

FIG. 11 shows a schematic view of triggering devices which are uniformly distributed on a first curtain of the present invention.

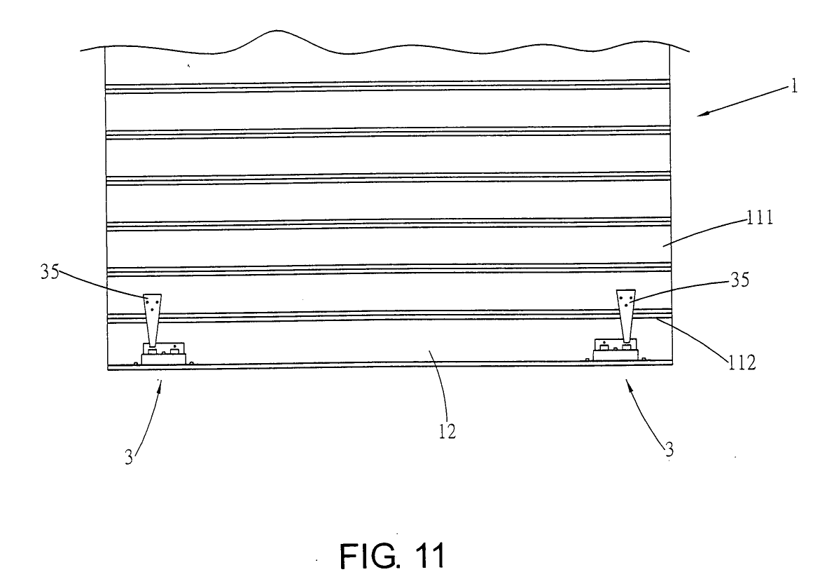

### DETAILED DESCRIPTION OF THE PREFERRED EMBODIMENTS

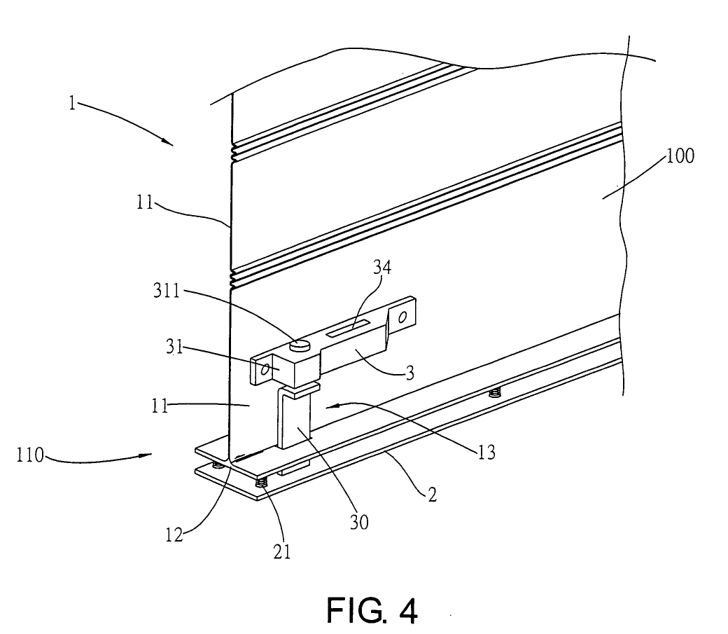

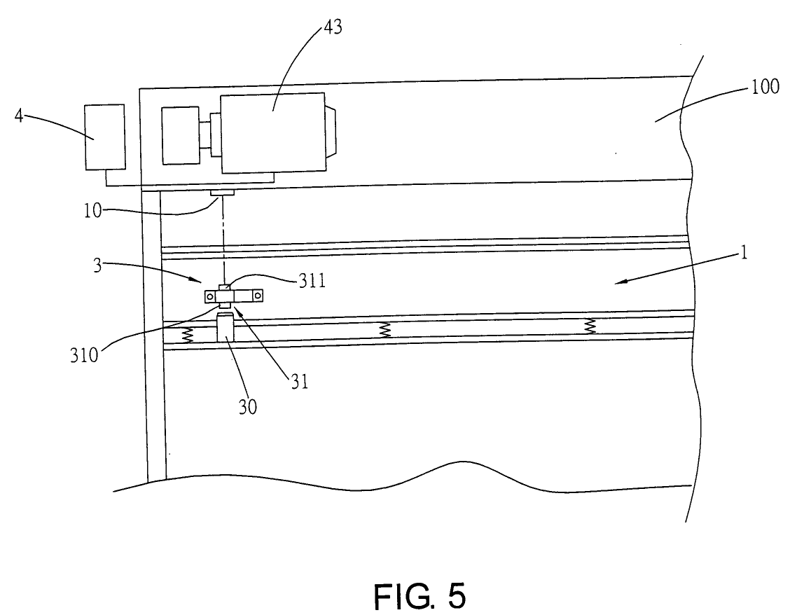

Referring to FIG. 4 and FIG. 5, the present invention comprises primarily at least two triggering devices 3, two tact devices 13, one guarding plate 2, one remote-control host 4, and one motor 43, wherein the triggering device 3 includes a first triggering key 310, a second triggering key 311, and an operating circuit 32, whereas the tact device 13 includes a tact piece 30 and a touch piece 10. The triggering device 3 is located at a lowest curtain 11 of a door leaf. A lower end of the curtain 11 is provided a trapezoidal hoof 12 which is connected to a guarding plate 2 via an elastic member 21.

A tact piece 30 is located between the triggering device 3 and the guarding plate 2 for performing an action that when a lower end of the guarding plate 2 encounters an alien object or reaches a ground to retrieve a reaction force, the tact piece 30 will be pushed up to press a triggering switch 31 via an deformation of the elastic member 21, and the tact switch operates such that the triggering device 3 generates a signal to a door 100. As shown in FIG. 4, the signal is received by a remote-control host 4 as a basis for serving commands to operate a working status of a motor 43.

In addition, when a triggering key 311 above the triggering switch 31 installed by the triggering device 3 is pressed by an elastic touch piece 10 located at a relative position of the door 100, it can be recognized that when the door 100 is rolled up to an upper dead point, a shutdown command is generated by the pressing of the touch piece 10 on the triggering key 311 installed by the triggering device 3. The shutdown signal will be transmitted to the remote-control host 4 to perform a shutdown operation to the motor 43. The triggering device 3 can operate in two ways.

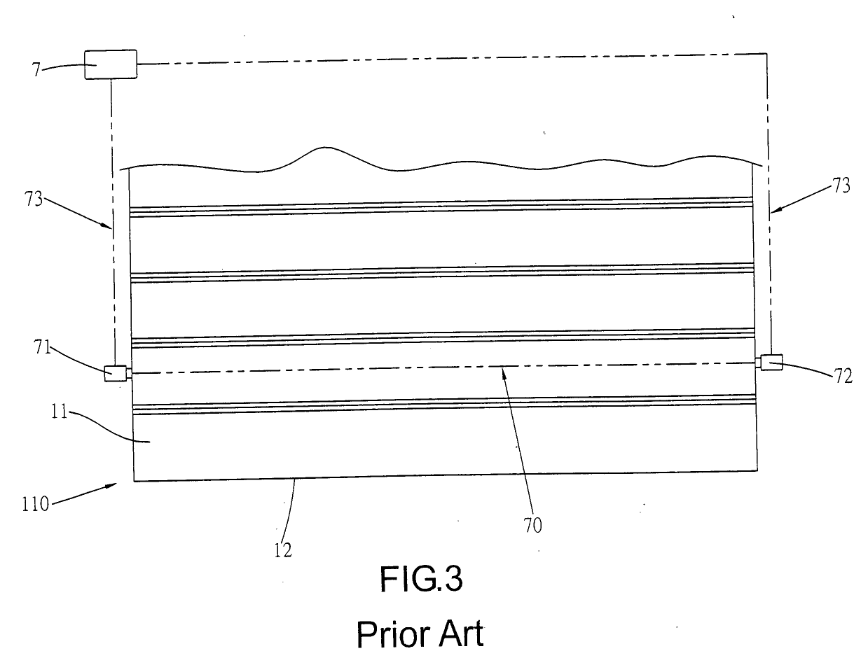

By all elements of the guarding plate 2 installed by a closing side 110 (as shown in FIG. 3), it can provide a safety protection and positions of upper and lower dead points to the door leaf during a retracting and collapsing process, and can provide a shutdown command of the upper and lower dead points using only the two-way function of the triggering device 3.

The triggering device 3 is also provided with a power alert device 34 which can generate a power alert signal to inform a user to supplement electric energy when the triggering device 3 is in short of electric energy. The signal can be a sound or a twinkling light. In addition, the signal can be emitted based on a determination of electric current of an electric energy supplying element, which is a common current induction design, and hence will not be described further.

Referring to FIG. 5, it shows an overall operation system of the triggering device 3. The triggering device 3 is provided with a two-way triggering switch 31 which includes a lower first tact key 310 and an upper second tact key 311. When the tact switch 31 receives an external force to operate, a signal is generated to an operating circuit 32 for forming a radio wave which will be emitted through an emitting side 33. The signal wave emitted by the emitting side 33 will be received by a receiving side 41 installed by the remote-control host 4 of the motor 43.

The remote-control host 4 acquires power from a power source 42; therefore, after the triggering switch 31 operates by the tact piece 30 or the touch piece 10, the radio signal wave generated will be transmitted to the remote-control host 4 which will conduct the motor 43 to perform a control of working status.

Moreover, the wave emitted by the emitting side 33 can be a radio wave or an infrared wave according to an application condition, in order to carry an induction signal for providing to the remote-control host 4. The remote-control host 4 can also accept a control of operation status with a remote controller 40 operated by one person. The signal wave emitted by the remote controller 40 has a same frequency as that emitted by the emitting side 33.

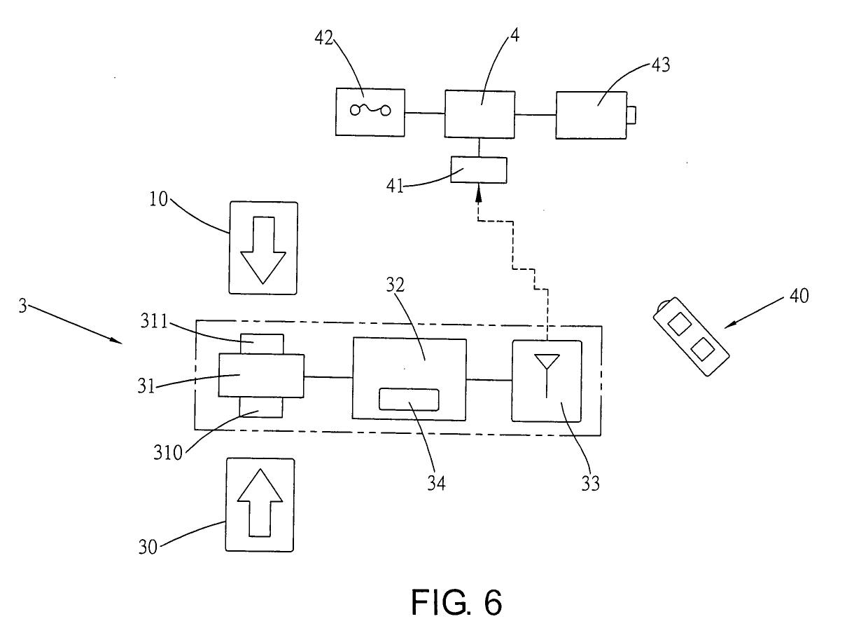

Referring to FIG. 6, at least two triggering devices 3 are linearly distributed along a longitudinal direction of the closing side 110 of the door leaf 1, wherein at least two triggering devices 3 are installed at positions close to left and right sides of the closing side 110. The triggering devices 3 receive an operation status of the guarding plate 2 through the tact pieces 30, so as to serve as a basis of tact.

When the closing side 110 of the door leaf 1 reaches a ground 5, as the guarding plate 2 is compressed on a basis of deformation of the elastic member 21, it will simultaneously push up the tact pieces 30, such that the tact pieces 30 will move up to act on the triggering devices 3. Therefore, the triggering devices 3 can emit a radio wave such that a remote-control host (as the remote-control host shown in FIG. 5) will acquire an operation command, in order to control an operation of the motor 43.

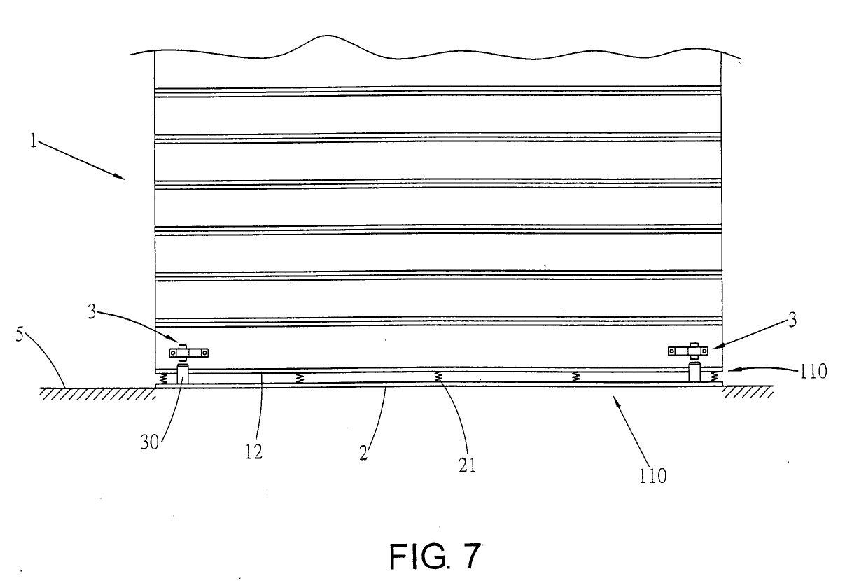

Referring to FIG. 7, the purpose of installing the triggering devices 3 at the left and right sides of the closing side 110 of the door leaf 1 is to use the guarding plate 2 which is a straight plate, such that if the guarding plate 2 touches a barrier 8 during a process of closing the door leaf 1, as shown in the drawing, then at least the triggering device 3 at the right side will be touched, thereby enabling the triggering device 3 to emit a shutdown signal.

As the guarding plate 2 is in a straight shape, which is connected to the closing side 110 installed by the door leaf 1 via the elastic member 21, therefore if its right side is pressed by the barrier 8, the triggering device 3 will be activated through the tact piece 30, and an angle θ will be formed between the guarding plate 2 and a lower rim of the door leaf 1.

Overall, if any location below the guarding plate 2 is pressed by the barrier 8, there is a chance that one of the triggering devices 3 will generate an induction signal, thereby acquiring a complete safety protection.

There are at least two triggering devices 3 installed for the present invention, and the minimum requirement is that the triggering devices 3 must be installed at the left and right sides of the closing side 110.

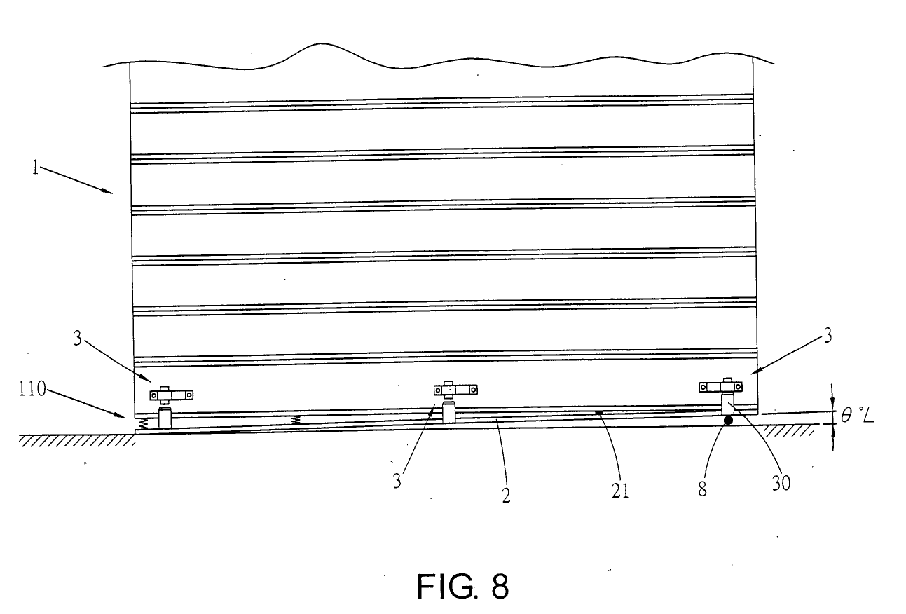

Referring to FIG. 8, an implementation of triggering the signal includes installing a triggering device 3 on the vertical hoof 12 of a first curtain 11. The triggering device 3 is provided with a first tact key 310 and a second tact key 311, wherein the first tack key 310 is acted by a first probing rod 35 whose fixing side is connected to a second curtain 111. A deformation band 112 is formed between the second curtain 111 and the first curtain 11. When the first curtain 11 encounters a resistance upon pressing the hoof 12 from top to bottom, a feedback to the resistance will be generated through the deformation band 112. As a contraction deformation will be generated by pressing the deformation band 112, and the fixing side of the first probing rod 35 is fixed on the second curtain 111, a relative contraction shifting will be generated between the hoof 12, so as to enable a foot side 351 of the probing rod 35 to touch the first triggering key 310 for generating a shutdown signal, thereby allowing the door leaf 1 to perform a designated action before reaching a ground surface in closing the door.

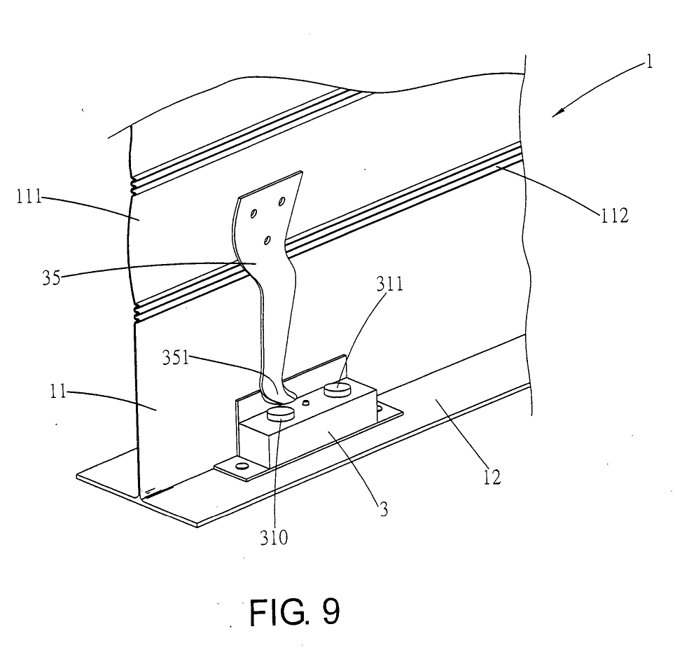

Referring to FIG. 9, when the door leaf 1 is rolled up to reach a top position, the second tact key 311 of the triggering device 3 will act on a second probing rod 36 installed on the door 110. By using a foot side 361 of the second probing rod 36 to touch the second tact key 311, a command signal can be generated to provide the remote-control host 4 for issuing a shutdown command to the motor 43.

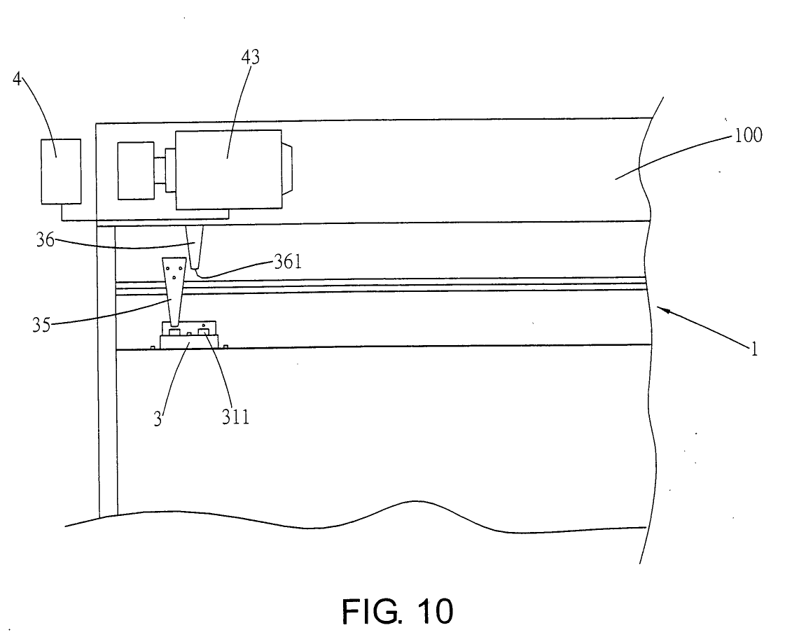

Referring to FIG. 10, two symmetric triggering devices 3 are distributed at the hoof 12 installed at a lower end of the door leaf 1. The triggering devices 3 are corresponding to each probing rod 35 to achieve a tact operation as shown in FIG. 8. By symmetrically distributing the triggering devices 3, a uniform action and a control at an effective timing can be available. In addition, under a circumstance that deformation stresses at left and right to the deformation band 112 are equal, a resisting force is also generated at a center of the door leaf 1; therefore, the triggering devices 3 at two sides can uniformly share the pressure and accept the designated signal activated separately by each probing rod 35.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A safety device of two-way braking for a retractable door leaf, comprising at least two triggering devices, two tact devices, one remote-control host, and one motor, wherein the triggering device is provided with an operating circuit and the tact device can perform an activation operation to the triggering device under an opening and closing status of a door leaf, respectively; the result of the aforementioned activation being that the operating circuit of the triggering device will generate a radio signal command to a remote-control host, in order to control a working status of a motor, and safely control positions of upper and lower dead points to the door leaf during a retracting and collapsing process.

2. The safety device of two-way braking for a retractable door leaf according to claim 1, wherein the retractable door leaf includes a guarding plate.

3. The safety device of two-way braking for a retractable door leaf according to claim 1, wherein the triggering device includes a first triggering key and a second triggering key.

4. The safety device of two-way braking for a retractable door leaf according to claim 1, wherein the tact device includes a tact piece and a touch piece.

5. The safety device of two-way braking for a retractable door leaf according to claim 1, wherein the tact device includes a first probing rod and a second probing rod.

6. A safety device of two-way braking for a retractable door leaf comprising at least two triggering devices, two tact devices, one guarding plate, one remote-control host, and one motor, wherein the triggering device includes a first triggering key, a second triggering key, and an operating circuit, with the first and second triggering keys being located at opposite positions below and above the triggering device, and the tact device includes a tact piece and a touch piece, with the tact piece being located at a position above the guarding plate at a bottom of door leaf, corresponding to the position of first triggering key, and the touch piece being located at a top of door leaf, corresponding to the position of second triggering key; the tact device performing an activation operation to the triggering device under an opening and closing status of door leaf, respectively, and the results of aforementioned activation being that the operating circuit of triggering device will generate a radio signal command to a remote-control host, in order to control a working status of a motor, and safely control positions of upper and lower dead points to the door leaf during a retracting and collapsing process.

7. A safety device of two-way braking for a retractable door leaf, comprising at least two triggering devices, two tact devices, one remote-control host, and one motor, wherein the triggering device includes a first triggering key, a second triggering key, and an operating circuit, with the first and second triggering keys being transversally located at parallel positions on the triggering device, and the tact device includes a first and a second probing rods; a fixing side of the first probing rod being fixed on a second curtain of door leaf, at a position corresponding to the first triggering key, and a foot side of the first probing rod being acted on the first triggering key through a deformation of curtains; the second probing rod being located on a top of door leaf, at a position corresponding to the second triggering key; the tact device performing an activation operation to the triggering device under an opening and closing status of door leaf, respectively, and the results of aforementioned activation being that the operating circuit of triggering device will generate a radio signal command to a remote-control host, in order to control a working status of a motor, and safely control positions of upper and lower dead points to the door leaf during a retracting and collapsing process.

8. The safety device of two-way braking for a retractable door leaf according to claim 1, wherein the triggering device can be further installed with a power alert device.

9. The safety device of two-way braking for a retractable door leaf according to claim 6, wherein the triggering device can be further installed with a power alert device.

10. The safety device of two-way braking for a retractable door leaf according to claim 7, wherein the triggering device can be further installed with a power alert device.

11. The safety device of two-way braking for a retractable door leaf according to claim 1, wherein the tact device installed by the door is made by an elastic material, in order to achieve a function of elastic buffering.

12. The safety device of two-way braking for a retractable door leaf according to claim 6, wherein the tact device installed by the door is made by an elastic material, in order to achieve a function of elastic buffering.

13. The safety device of two-way braking for a retractable door leaf according to claim 7, wherein the tact device installed by the door is made by an elastic material, in order to achieve a function of elastic buffering.

14. The safety device of two-way braking for a retractable door leaf according to claim 1, wherein an infrared wave or a radio wave can be transmitted between the triggering device and the remote-control host.

15. The safety device of two-way braking for a retractable door leaf according to claim 6, wherein an infrared wave or a radio wave can be transmitted between the triggering device and the remote-control host.

16. The safety device of two-way braking for a retractable door leaf according to claim 7, wherein an infrared wave or a radio wave can be transmitted between the triggering device and the remote-control host.

17. The safety device of two-way braking for a retractable door leaf according to claim 1, wherein the remote-control host can be operated by another remote controller.

18. The safety device of two-way braking for a retractable door leaf according to claim 6, wherein the remote-control host can be operated by another remote controller.

19. The safety device of two-way braking for a retractable door leaf according to claim 7, wherein the remote-control host can be operated by another remote controller.
